(19) United States
(12) Patent Application Publication
(10) Pub. No.: US 2004/0213422 A1
(43) Pub. Date: Oct. 28, 2004

(54) Pollable transformer isolated speaker system and method

(75) Inventor: Angelo S. Arcaria, Wethersfield, CT (US)

Correspondence Address: BAKER & HOSTETLER LLP, Washington Square, Suite 1100, 1050 Connecticut Avenue, N.W., Washington, DC, 20036, US

(73) Assignee: EDWARD SIGNALING TECHNOLOGY, INC.

(21) Appl. No.: 10/423,914

(22) Filed: Apr. 28, 2003

(51) Int. Cl. H04R 3/00; H04R 1/00; H04R 9/06; H04R 11/02

(52) U.S. Cl. 381/111; 381/117; 381/401

(57) ABSTRACT

A speaker system utilizes an isolation transformer with an independent secondary coil to produce power for a poll back response circuit.

### FIELD OF THE INVENTION

The present invention generally relates to voice and tone audio distribution systems. More particularly, the present invention relates to voice and tone audio distribution systems having transformer isolated speakers capable of recording and/or receiving zone data.

### BACKGROUND OF THE INVENTION

Conventional industrial and commercial voice and tone audio distribution systems typically use transformer isolated speakers to facilitate the distribution voice and tone sounds. Transformer-isolated speakers are commonly powered by a two wire pair coming from either an audio paging source or an Emergency/Signaling/EVAC panel. When the primary coil is energized, electromagnetically induced power for the transformer-isolated speakers is generated in the secondary coil of the isolated speakers to power the speakers. Conventionally, the transformer-isolated speakers are single function in nature, in that they operate only to provide voice and/or tone sounds. Due to the transformer isolation nature of these speaker systems, these speakers have an advantage in that they do not require an external power source to operate. Unfortunately, the speakers cannot provide or report supervisory status since the attendant support electronics require an independent power source.

To provide a dedicated power supply, the incorporation of separate sets of 120 VAC or 240 VAC wires from a power source is necessary. Of course, the inclusion of separate power wires requires additional installation cost arising from providing for example raceways, conduits, and safety barriers for the power lines. The added cost of installing additional power lines has been a deterrent to the implementation of zone reporting voice and tone audio distribution systems.

Accordingly, there has been a long standing need to provide methods and systems for a pollable reporting voice and tone audio distribution system that does not require the installation of additional power lines.

### SUMMARY OF THE INVENTION

The foregoing needs are met, to a great extent, by the present invention, wherein in one aspect an apparatus is provided that in some embodiments facilitates voice and tone audio distribution systems using transformer isolated speakers capable of conveying supervisory status information without incorporating additional power lines.

In accordance with one embodiment of the present invention, a pollable speaker system is provided having an audio transformer with a multi-tap primary coil and a secondary coil connected to a speaker. The system contains an additional secondary coil and a poll response controller connected to the additional secondary coil, wherein the controller is powered from energy generated in the additional secondary coil.

In accordance with another embodiment of the present invention, a pollable speaker system is provided having an audio transformer with a multi-tap primary coil and a secondary coil connected to a speaker. An additional secondary coil is connected to, and powers a poll response controller which is connected to a separate device controller or wireless system.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a schematic diagram of an exemplary embodiment according to this invention.

FIG. 2 is a timing diagram showing waveforms occurring in an exemplary embodiment of this invention.

FIG. 3 is a schematic diagram of a transformer isolated speaker system.

### DETAILED DESCRIPTION

An embodiment in accordance with the present invention provides systems and methods for a pollable transformer isolated speaker system without requiring additional power lines to power the supporting poll response electronics. Embodiments of the invention will now be described with reference to the drawing figures, in which like reference numerals refer to like parts throughout.

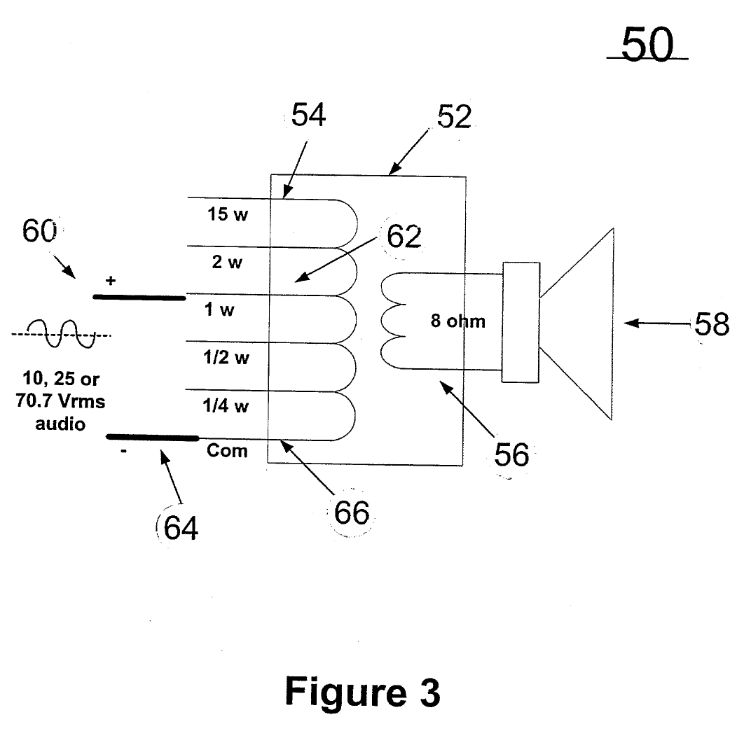

FIG. 3 is a schematic diagram of a conventional commercial voice and tone audio distribution system 50. The commercial system 50 is essentially comprised of a isolation audio transformer 52 having a multi-tap primary coil 54 in close proximity to a secondary coil 56 connected to a speaker 58. FIG. 3 illustrates the speaker 58 as having a conventional 8 Ohm impedance. The multi-tap primary coil 54 of the transformer 52 has a selection of power taps encompassing ¼ watts to 15 watts. If speaker 58 is required to produce 1 watt of audio power, the installer of the system will connect one of the 10, 25 or 70.7 VRMS audio feed 60 lines to the 1 watt tap 62 of the multi-tap primary coil 54 and the remaining 10, 25 or 70.7 VRMS audio feed 64 line to the COM tap 66 of the multi-tap primary coil 54.

The 10, 25 or 70.7 VRMS audio lines 60, 64 feed into the multi-tap primary coil 54 to induce an audio output voltage through the secondary coil 56 which directly drives the 8-Ohm speaker 58. The greater the primary power tap selection of the multi-tap primary coil 54, the higher the voltage will be across the secondary coil 56. Accordingly, as shown in FIG. 3, the speaker does not require any other external power source.

However, as apparent from FIG. 3, the audio distribution system 50 limits the transfer of energy from the multi-tap primary coil 54 to only the secondary coil 56. Therefore, even if the speaker system 50 is modified with support electronics to report supervisory status, it cannot do so without the incorporation of a separate dedicated power supply. In order to provide a separate dedicated power supply, additional power wires from either a 120 VAC or 240 VAC power source is required. The incorporation of additional power lines to the speaker system 50 requires the expensive implementation of, for example, raceways, high voltage conduits. Accordingly, conventional voice and tone audio display systems cannot be easily modified to provide supervisory status information without incurring significant costs.

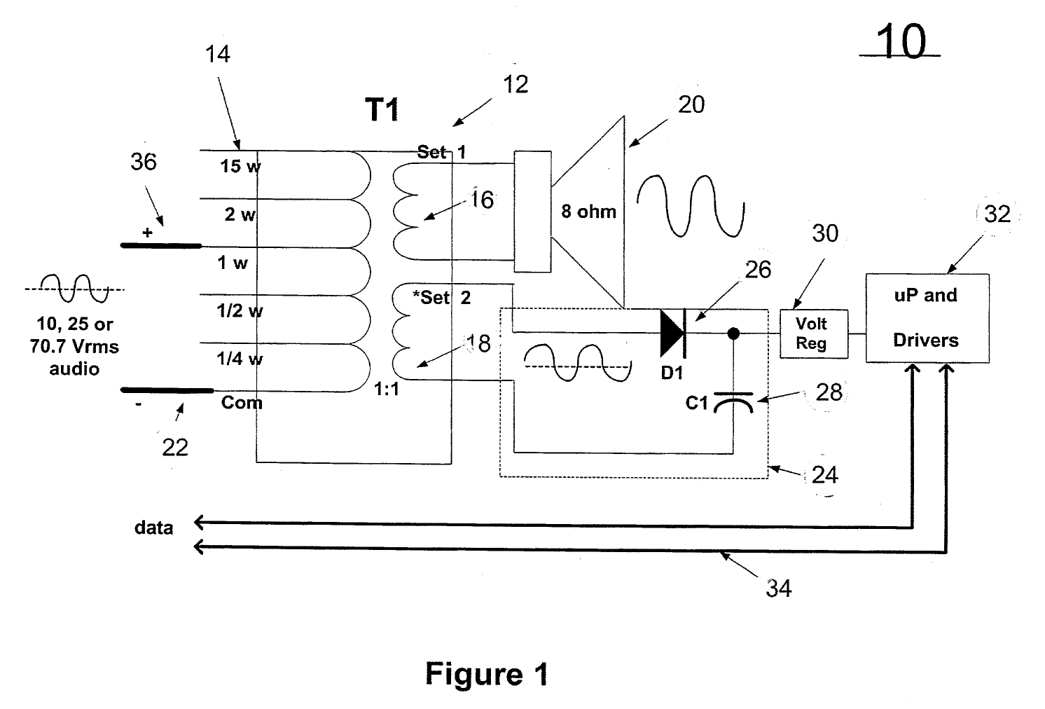

FIG. 1 is a schematic diagram of an exemplary embodiment 10. The exemplary embodiment 10 comprises an isolation transformer 12 (T1) having a multi-tap primary coil 14 and a secondary coil 16, and an additional secondary coil 18. The secondary coil 16 is connected to a speaker 20, preferably, but not necessarily of 8 Ohms. The multi-tap primary coil 14 contains a selection of tap points from ¼-15W, for example. COM tap 22 is provided as a common tap for the multi-tap primary coil 14. The additional secondary coil 18 is connected in series to a rectifying power circuit 24. The rectifying power circuit 24 is in the form of a serially connected diode 26 (D1) and a parallel connected large reservoir capacitor 28 (C1). Connected in series to the rectifying power circuit 24 is a voltage regulator 30 and support electronics comprising a microprocessor/signal driver 32. The microprocessor/serial driver 32, in turn, is also connected to a bi-directional data bus 34 to an audio power controlling source. The bi-directional bus 34 may be uni-directional, if desired.

The primary coil 14 of the isolation transformer 11 is designed to afford a 1:1 turns ratio to the isolation transformer's 12 additional secondary coil 18. Therefore, when the multi-tap primary coil 14 is energized, an equivalent energy is induced into the additional secondary coil 18. In operation, the multi-tap primary coil 14 is connected to a 10, 25 or 70.7 VRMS audio power source via any one of the selected taps. In this exemplary embodiment the multi-tap primary coil 14 is connected to the 10, 25 or 70.7 VRMS audio power source via the 1 Watt tap 36 and the COM tap 22.

It should be appreciated that, though FIG. 1 illustrates the use of a 10, 25, 70.7 VRMS audio power source, any other power source having a different VRMS rating may be used, as desired. Additionally, while a ratio of 1:1 is used between the primary coil 14 and the additional secondary coil 18, other ratios may be used without departing from the spirit and scope of this invention. For example, one of the ratios equivalent to any of the non-selected taps of the primary coil 14 may be used, to provide the necessary energy to the additional secondary coil 18. Further, the rectifying power circuit 24 is illustrated as being formed from a simple diode 26 and a capacitor 28. However, it is well known that other rectifying power circuits using amplifiers, bridges, switches, etc. may be used to provide the equivalent function. Alternative rectifying circuits and, therefore, other forms of rectifying power circuits or devices may be implemented, as desired. Similarly, it should be appreciated that the voltage regulator 30 of FIG. 1 may be replaced or complemented with a battery that is chargeable.

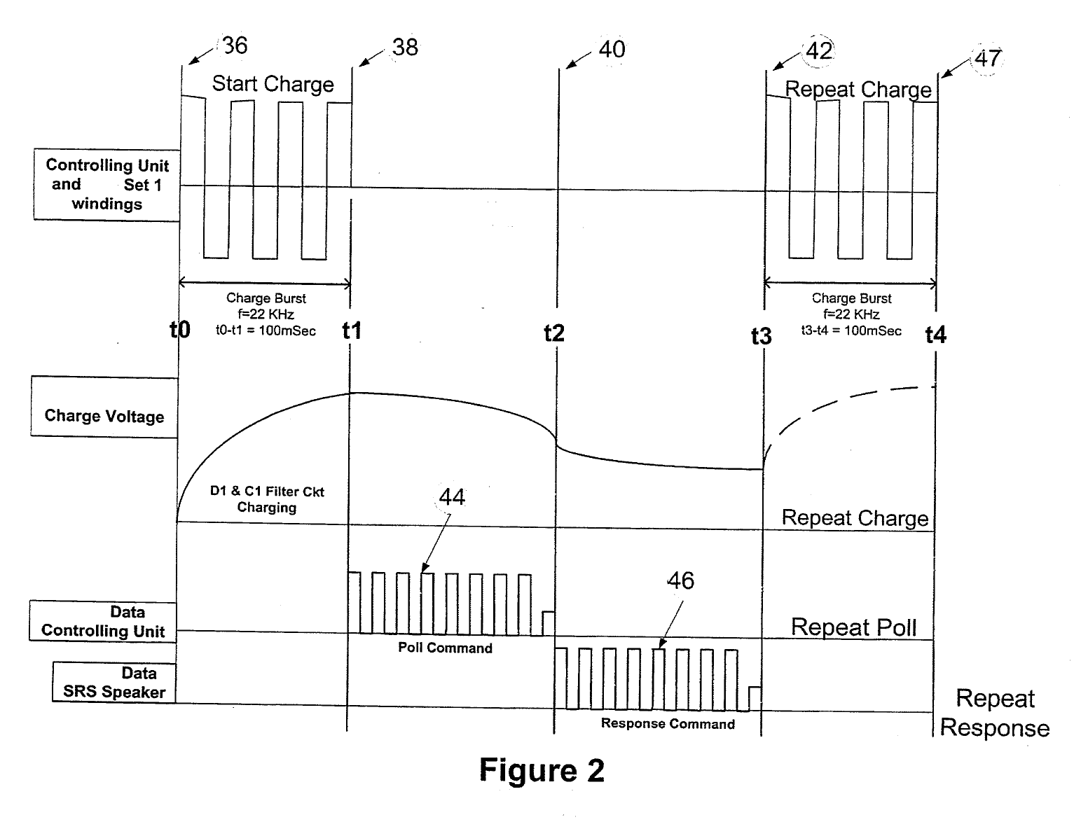

While FIG. 2 illustrates the microprocessor/signal drivers 32 as a single element, the microprocessor/signal drivers 32 may be separately devised accordingly to design preferences. Therefore, the microprocessor may be a simple logic device reporting only binary status information or may be more sophisticated, providing computing and/or controlling capabilities using resident loaded software or remotely loaded software.

When the microprocessor/signal drivers 32 need power for status reporting, the audio source must first provide a 10, 25 or 70.7 VRMS charge burst to the selected power taps of the isolation transformer 12. The charge bursts are in a frequency range outside the human audible range (approximately greater than 22 kHz) for approximately 100 milliseconds. Providing a charge burst signal outside the human audible range makes it virtually impossible to hear the charge burst cycle through the speaker, while providing the necessary power for performing supervisory functions.

During the charge burst cycle, rectified energy from the diode 26 will be stored in the capacitor 28. At the end of the charge burst cycle, the capacitor 26 will start to discharge its stored energy into the voltage regulator 30. The voltage regulator 30 will operate to regulate the discharge of energy from the capacitor 28 and supply the necessary power to the supporting electronics (e.g., microprocessor/signal drivers 32) for data encoding and poll back response to the controlling audio source via data lines 34. Once the poll interrogation and response has ended, the exemplary system 10 will have consumed the energy stored in the capacitor 28 and will require a subsequent charge burst on the next poll. If more than one supporting electronics 32 is connected on the system, then subsequent charge bursts, intended for other supporting electronics, will keep the exemplary system 10 operating and ready for the next poll response.

FIG. 2 illustrates an exemplary timing diagram for the exemplary embodiment of FIG. 1. An exemplary charge per cycle comprises four timing periods t0-t1, t1-t2, t2-t3, and t3-t4 (36-47). The first timing period begins at t0 36 and ends at t1 38. The second timing period begins at t1 38 and ends at t2 40. The third timing period begins at t2 40 and ends at t3 42. Each of the timing periods may be of uniform time duration or of arbitrarily different time duration. In this exemplary embodiment, the timing periods are shown as having a uniform time duration of approximately 100 mSec.

In the first time period between t0 136 and t1 38, speaker 20 and the additional secondary coil 18 will receive a series of charge bursts between t0 36 and t1 38 from the primary transformer taps 14 generated by the 10, 25 or 70.7 VRMS audio power source. At that point capacitor 28 will begin to store energy. At the end of the first time period t1, the capacitor 28 will have enough stored energy to power up the microprocessor/signal drivers 32, enabling them to process subsequent polling commands and to provide response signals via the bi-directional data bus 34.

At the start of the second time period t1 38, the audio power controlling source can begin to issue a poll command 44 to the exemplary speaker system 10 over the data bus 34. Upon receipt of the poll command 44, the microprocessor/signal drivers 32 processes the command and prepares a response. At the beginning of the third time period t2 40 the microprocessor/signal drivers 32 can return a response signal 46 to the audio power controlling source over data bus 34. If a timeout occurs for an arbitrary reason, the audio power controlling source may re-issue charge bursts as shown in FIG. 2, between t3 42 and t4 47 prior to the next polling response period. If no timeout occurs, the process is repeated at the end of the third time period t3 42.

Upon receipt of the polling response 46 by the audio power controlling source, the audio power controlling source may issue further polling iterations or commands to the exemplary speaker system 10 to perform, if desired, switching or controlling functions for other devices that maybe connected to the system 10. For example, lights, other speaker systems, or door locks, may be controlled by the system 10.

Therefore, in view of the above, it should be appreciated that while FIG. 2 illustrates communications as being only facilitated between the audio power controlling source and the microprocessor/signal lines 32 via bi-directional lines 34, communications and control commands to other devices may be accomplished by additional lines connected to the microprocessor/signal lines 34. Furthermore, while the exemplary embodiments show communications occurring via the bi-directional lines 34, non-wired or wireless means for communicating with the audio power controlling source, a central system, or other devices.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A pollable speaker system having an audio transformer with a multi-tap primary coil and a first secondary coil connected to a speaker, comprising:
a second secondary coil; and
a poll response controller connected to the second secondary coil, wherein the controller is powered from energy generated in the second secondary coil.

2. The pollable speaker system of claim 1, wherein the controller comprises:
a power storage device; and
a responder device connected to the storage device.

3. The pollable speaker system of claim 1, wherein the storage device comprises:
a rectifier;
a capacitor connected to the rectifier; and
a voltage regulator connected to the rectifier and capacitor.

4. The pollable speaker system of claim 2, wherein the rectifier is a diode.

5. The pollable speaker system of claim 3, wherein the storage device further comprises a rechargeable battery.

6. The pollable speaker system of claim 1, wherein the responder device is a microprocessor.

7. The pollable speaker system of claim 6, wherein the responder device includes a signal driver.

8. The pollable speaker system of claim 7, wherein the signal driver is connected to a data bus.

9. The pollable speaker system of claim 7, wherein the signal driver is connected to an antenna.

10. The pollable speaker system of claim 1, wherein the controller is further connected to a switchable device.

11. An audio isolation transformer, comprising:
a multi-tap primary coil;
a first secondary coil;
a second secondary coil; and
a poll response controller connected to the second secondary coil, wherein the controller is powered from energy generated in the second secondary coil.

12. The transformer of claim 11, wherein the controller comprises:
a power storage device; and
a responder device connected to the storage device.

13. The transformer of claim 11, wherein the storage device comprises:
a rectifier;
a capacitor connected to the rectifier; and
a voltage regulator connected to the rectifier and capacitor.

14. The transformer of claim 13, wherein the rectifier is a diode.

15. The transformer of claim 13, wherein the storage device further comprises a rechargeable battery.

16. The transformer of claim 11, wherein the responder device is a microprocessor.

17. The transformer of claim 16, wherein the responder device includes a signal driver.

18. The transformer of claim 17, wherein the signal driver is connected to a data bus.

19. The transformer of claim 17, wherein the signal driver is connected to an antenna.

20. The transformer of claim 11, wherein the controller is further connected to a switchable device.

21. A method for polling a speaker system having an isolation audio transformer and an inductively powered poll response controller, comprising the steps of:
sending a time limited burst of out-of-audible-range electrical charges to the audio transformer;
storing inductively generated energy from the burst;
powering the controller with the stored energy;
sending a polling command to the controller; and
responding to the polling command using the stored energy.

22. A pollable speaker system having an audio transformer with a multi-tap electromagnetic energy inducing means and a first induced energy receiving means connected to a sound producing means, comprising:
a second induced energy receiving means;
an induced energy rectifying means connected to the second induced energy receiving means;
a energy storage means connected to the induced energy rectifying means;
a poll response processing means connected to the energy storage means; and
a poll response signaling means connected to the poll response processing means.

23. The pollable speaker system of claim 22, wherein the energy storage means further comprises a voltage regulator means.

24. The pollable speaker system of claim 22, further comprising a switchable device means connected to the poll response processing means.
